(19) United States
(12) Patent Application Publication
(10) Pub. No.: US 2023/0305946 A1
(43) Pub. Date: Sep. 28, 2023

(54) HARDWARE DEVELOPMENT SYSTEM

(71) Applicant: MIKROELEKTRONIKA D.O.O., ZEMUN (RS)

(72) Inventors: Nebojsa MATIC, Belgrade (RS); Darko JOLIC, Zemun (RS); Ivan RAJKOVIC, Belgrade (RS); Srdjan TOMIC, Zemun (RS)

(73) Assignee: MIKROELEKTRONIKA D.O.O., ZEMUN (RS)

(21) Appl. No.: 17/704,043

(22) Filed: Mar. 25, 2022

(51) Int. Cl. G06F 11/36

(52) U.S. Cl. CPC G06F 11/3656; G06F 11/3664

(57) ABSTRACT

A system for hardware and software development comprising a development system that includes a hub portion operative to receive debugged signals and send and receive commands to a microcontroller portion and a debugging portion communicatively connected to the hub portion. The system further includes a multiplexor communicatively connected to the hub portion and a development board communicatively connected to the debugger portion and the multiplexor. Methods, terminals and computer readable media are also disclosed.

### FIELD OF THE DISCLOSURE

This disclosure relates to a hardware development system.

### BACKGROUND OF THE DISCLOSURE

Hardware development systems are often used to debug and test the operation of a processing device or other devices. Such systems may include an integrated software environment and a development board.

Mann (U.S. Pat. No. 6,618,854) proposes a remotely accessible integrated debug environment that permits a user having a computer and internet connection to remotely access an Integrated Development Environment.

It is desirable to design and operate a hardware development system that improves the performance and design of the system.

### BRIEF SUMMARY OF ONLY SEVERAL ASPECTS OF DISCLOSURE

A system for hardware and software development comprising a development system that includes a hub portion operative to receive debugged signals and send and receive commands to a microcontroller portion and a debugging portion communicatively connected to the hub portion. The system further includes a multiplexor communicatively connected to the hub portion and a development board communicatively connected to the debugger portion and the multiplexor.

A method for operating a system includes receiving an input from a user on a processing device, the input indicating a hardware device selected by the user, receiving an indication that a hardware device is installed in the system, and presenting a representation of the hardware device to the user on a display screen. The method further includes providing the user with a graphical representation of the system, providing the user on the screen graphical representations of controls associated with the hardware device, and receiving an input from a user, the input is operative to control and debug the hardware device, wherein the system is operative to emulate or change the connections of the hardware device using a hub portion of the system.

A method, terminal, system, signal, or transitory or non-transitory computer readable medium includes instructions for receiving an input from a user on a processing device, the input indicating a hardware device selected by the user, receiving an indication that a hardware device is installed in the system, presenting a representation of the hardware device to the user on a display screen, and providing the user with a graphical representation of the system. The method further includes providing the user on the screen graphical representations of controls associated with the hardware device and receiving an input from a user, the input is operative to control and debug the hardware device, wherein the system is operative to emulate or change the connections of the hardware device using a hub portion of the system.

### BRIEF DESCRIPTION OF THE DRAWINGS

In the accompanying drawings, which form a part of the specification and are to be read in conjunction therewith, and in which like reference numerals are used to indicate like features in the various views:

FIG. 1 illustrates an example of a prior art hardware development system;

FIG. 2 illustrates an example a system, according to embodiments;

FIG. 3 illustrates another example of a system, according to embodiments;

FIG. 4 illustrates another example of a system, according to embodiments;

FIG. 5 illustrates another example of a system, according to embodiments; and

FIG. 6 illustrates another example of a system, according to embodiments.

### DETAILED DISCLOSURE OF EMBODIMENTS

An embedded development tool chain includes an integrated software environment that has an editor, a compiler, a programmer, and a debugger. The tool chain also includes a development board, that may include indicators such as visual indicators like light emitting diodes and displays. The development board may include sensors and actuators, inputs such as buttons, potentiometers, touch panels and other input and output devices. The development board may also include interfaces for a personal computer or other type of processing device such as in examples, a universal asynchronous receiver transmitter, a universal serial bus, and transmission control protocol/internet protocol.

In embodiments described herein a hardware development system includes a feature of identifying different parts of a board through a hub and debugger module. In embodiments the system may automatically adapt the software environment to a connected development board. The system may change the hardware connections and configurations via a hub and a multiplexor. The hub portion is operative to generate output or record input, which enable the hub portion to emulate they system as new hardware parts are added to the development board. This provides remotely configurable hardware topology with programing and debugging and real environment excitation and monitoring. The system can time synchronize or script and allows for remote system control.

Systems described herein provide wired or wireless connections between the components of the system(s) such that when connected over a network such as, for example, a local network or the Internet may allow users to control various parts of the system remotely.

The use of a hub module and multiplexor allows the system to control various modules or development boards, extension boards and related input and output devices over a network allowing hardware to be tested and operated.

Manual reconfiguration of the development board will be reduced, and maintenance and system costs may be reduced. Many hardware changes to the development system may prompt the production of new hardware and printed circuit boards. The system may allow users to test hardware changes without introducing new tangible hardware. The configuration may be performed by the system automatically and displayed on a terminal at a remote location. The hardware may be configured remotely without physically controlling or configuring the hardware.

In embodiments described herein a system that allows standardized remote configuration and autodetect of the hardware topology and changes to the topology, and synchronized control, excitation, monitoring, programming, debugging of hardware systems.

In embodiments, the system may be used as an electronic system and may perform a function having remotely configurable hardware topology. The system may emulate new hardware modules connected to the system. The system provides autodetection or remote detection and configuration of tangible hardware modules that a user adds to the system. Programming and debugging with real environment excitation and monitory. The system may perform time synchronized remote system control. A user may control and work with the system on a remotely operated computer or processing device.

Such a system may be used by developers to maintain and test or produce computer code for embedded microcontroller systems, and for development and selection of a preferred hardware structure of system. They system may be used to perform production of embedded systems and the maintenance of field deployed devices.

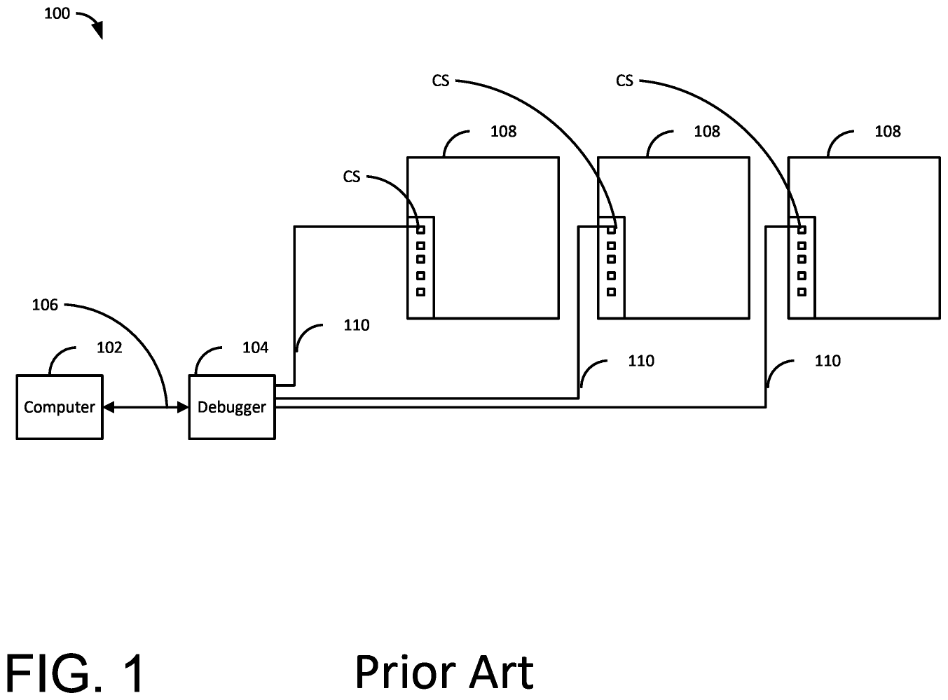

FIG. 1 illustrates an example of a prior art hardware development system 100. The system 100 includes a computer 102 that is communicatively connected to a debugger device 104 via a wired or wireless connection 106. The debugger device 104 is communicatively connected to the CS pins of several development boards 108 via communicative connections 110.

The examples according to FIG. 1 provide a connection between the CS pins of the development boards to the debugger device 104, however such an arrangement uses several interface lines (communicative connections) 110 and uses more processing power than desired. Such a system uses a local and remote computer device connected via a network.

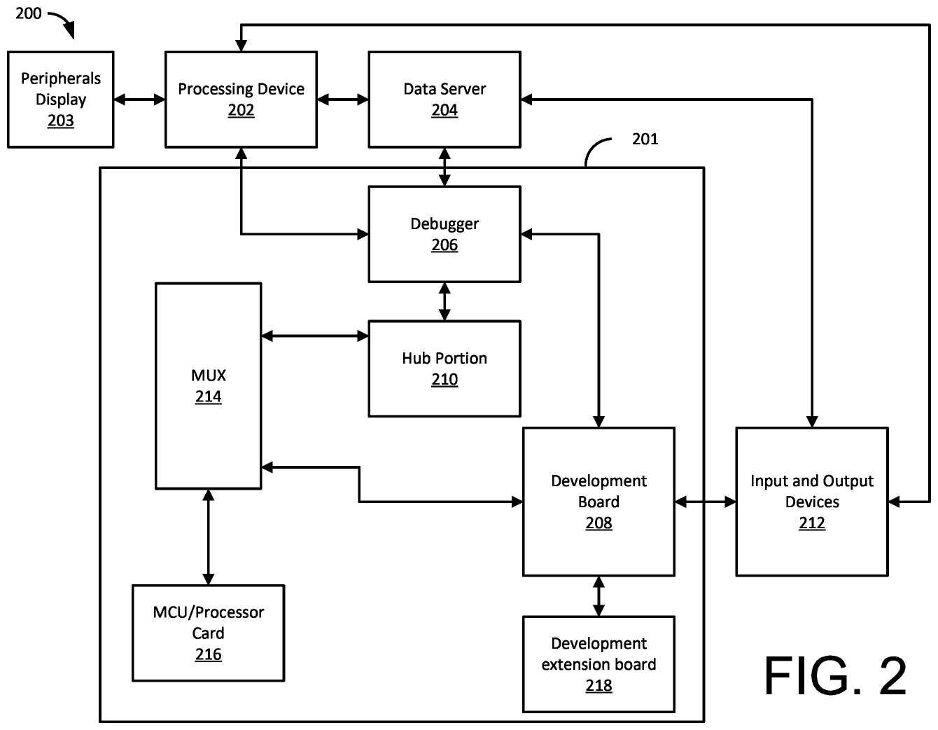

FIG. 2 illustrates example system 200 that includes a development system 201. System 200 includes a processing device 202 that may include, for example, a computer, tablet, or other smart device having a graphical user interface and may include peripherals 203 such as a display screen, keyboard, mouse or other input and output devices. Processing device 202 is communicatively connected to a debugger 206 of the development system 201 and to a data server 204. The data server may be omitted in embodiments. The data server(s) 204 may include, for example, a web server, Internet server, or other network server. The communicable connection between the processing device and the data server 204 may include a wired or wireless connection. The data server(s) 204 is communicatively connected to a debugger 206 of the development system 201. The data server(s) 204 is operative to connect to the debugger 206, and logs acquired data on a local or remote storage system. The debugger 206 is communicatively connected to a development board 208 and a hub portion 210. The debugger module has remote programing and debugging features and is communicatively connected to the hub portion 210 and the development board 208 via wired or wireless connections. Input and output devices 212 may be communicatively connected to the development board 208 over a wired or wireless network, to the processing device 202, and in embodiments, to the data server(s) 204 via a wired or wireless connection. The input and output devices 212 may communicate with the data server 204 using, for example, a representational state transfer application programing interface (REST API). The hub portion 210 is communicatively connected to a multiplexor (MUX) 214. The multiplexor 214 is communicatively connected to the hub portion 210, the development board 208 and a processor card 216 such as, for example, a micro controller unit (MCU) card. The development board 208 may be communicatively connected to any number of development extension boards 218.

In operation, an application with a graphical user interface is presented to a user by the processing device 202. The application on the data server (e.g., a web server application) connects to a remote debugger system (debugger) 206 via a network connection and performs tasks such as logging acquired data in a remote or local storage system.

The input and output devices 212 are communicatively connected to the data server 204 and the development board 208. The input and output devices 212 may be connected via a wired or wireless network connection. The input and output devices may include, for example, a signal generator, an oscilloscope, a camera, or any other device used for testing.

The hub portion 210 generates and routs electrical signals (on demand) through the multiplexer 214 to the processor card 216, the development board 208.

The multiple development boards 208 may be arranged together with any sort of configuration, for example, electrical, mechanical, magnetic, or adhesive. The development extension boards 218 may have any number of wired or unwired data connections. The development extension boards 218 may also include a micro controller unit or processor cards. The processor card 216, extension boards 218, or any HW part may for example, include an electrically erasable programable read-only memory (EEPROM) chip with one-wire communication such as, for example, an identification chip. In operation an ID chip on a processor card 216, development extension board 218 or an input and output device 212, or any HW module equipped with ID allows the debugger 206 and the hub portion 210 to obtain the ID of the ID chip and manifest file each hardware component that is present in the system. In embodiments, the system 200 may be configured to detect a connection in the system and of additional modules. The system 200 may read the ID and manifest file of the hardware and send the manifest file to the data server 204 and/or the processing device 202.

The system 200 may, in embodiments, include input and output modules 212 that may include output devices for monitoring such as cameras, measurement and monitoring devices such as, for example an oscilloscope. The input and output modules 212 may be connected over a network or Internet connection and may be configured using such connections. Input modules may also be used and may include, for example, signal generators, shakers and similar excitatory devices that may connect to the system 201 and to processing device 202 and optionally to Data server 204 via a network such as the Internet.

In embodiments, system 200 is operative to remotely configure hardware topology. The system may automatically detect a hardware change in the system 200. Thus, the system 200 is configurable by adding or removing hardware while the system is operating. The hub 210 and multiplexor 214 allow the system 200 to change connections between existing modules and may emulate the addition of some hardware modules when requested by a user. The emulated modules are not tangibly present, but rather are emulated via the hub 210 and multiplexor 214. The hub 210 and multiplexor 214 may disconnect hardware modules from the system 200. The system 200 has a remotely configurable hardware environment that allows for excitation and monitoring in a time synchronized scripting system configuration and control environment. Hardware modules may include portions of the development board, an extension board, or a separate module board connected to the development board or an extension board.

In operation, a user may start an application on the processing device 202. The application connects the processing device 202 to the data server 204 and scans available HW systems. The processing device 202 requests what available remote hardware debugging systems and input and output (I/O) modules 212 are available. The data server 204 may send a broadcast message to the registered input and output modules 212 and return the obtained data to the user application on the processing device 202. The processing device 202 may scan and identify remote hardware debugging systems directly if the data server 204 is not present in the system. In such a case, the system 200 replies with the current configuration of all active hardware modules and their manifest files. The manifest files may include, for example, information about the type and capabilities of an extensions board, a processor board 220, and all the input and output devices 212 and the ways the components are connected.

The user selects on the processing device 202 which system 200 and input and output device 212 the user desires to work with and is presented with identifications of the input and output devices 212 and the capabilities of each part of the system 200 and input and output devices 212. The user can change the configuration and topology of the wired and wireless connections remotely using the processing device 202 using the debugger 206 and the hub portion 210 with the multiplexor 214. The received identification and manifest file associated with at least one of a hardware module or input and output device 212 that allows the configuration of the software on the processing device 202 and the drivers and related set up of the software to be performed without substantial user interaction.

When a user changes the hardware topology, connections routing, and defines signals that will be generated or measured by the hub portion 210 the processing device 202 may send to the debugger 206 software defined buttons and other components via a network or the Internet as commands such that the hub portion 210 may make or record electrical signals on development system 201. The user may change how a hardware module, input, and output device 212 is connected. The user may induce the hub portion 210 generate an electrical signal as a new hardware module or when an input and output device 212 is presented. Such a signal may include, for example, a button, and input/output circuit, a pin, an analog output from a knob or a waveform signal from a signal generator. The ID capable, hardware modules and input and output devices 212 allows the system 200 to identify connections and reroute connections or introduce signals and connections associated with commands and settings input by the user in the processing device 202.

In the system 200 the user may control the code for the debugging and programing of the system 200. The user may change connections, signals, and hardware topology on remote or local locations. Such features may be achieved remotely over a network connection without the physical presence of the user to any hardware module or input and output devices 212. This is facilitated by the hub 210 and multiplexor 214 of the system. If new hardware is added to the system 200, the identification chip and manifest file that describes at least one of the capabilities of the hardware module and input and output device 212 may be read and added to the system automatically and presented to the user on the processing device 202.

In embodiments, additional hardware or equipment may be added to the system 200 if the hardware (input and output device 212) may connect to a network such as, the Internet and may respond to broadcast messages from the data server 204. Such capabilities may allow an input and output device 212 to connect to the system if the input and output device 212 can send and receive commands over a standardized API. The input and output device 212 may include, for example, cameras with live streaming, oscilloscopes, signal generators, shakers, and other similar input and output devices 212.

In embodiments, a user interacts with the system 200 by using the processing device 202 that may present a count of HW modules, the input and output devices 212 and their configuration and connections. The debugger 206 and hub portion 210 may automatically detect connected, hardware modules, input, and output devices 212 via, for example, a one wire identification bus. The application on the processing device 202 presents images that indicate, the hardware modules, the input and output devices 212, and their connections. The interface presents images that allow the user to interact with the hardware modules and input, output devices 212 via the graphical user interface. The user may define and interact with the system before and during a debugging procedure by performing actions in the application on the graphical user interface of the application running on the processing device 202 or by sending the application a script file that the application uses to transform the script file to synchronized actions and commands in the system 200. The application running on the processing device 202 provides the feature of allowing the user to configure, change, control, debug and monitor the system by watching outputs such as, for example, live video streams, oscilloscope outputs, or as logged data.

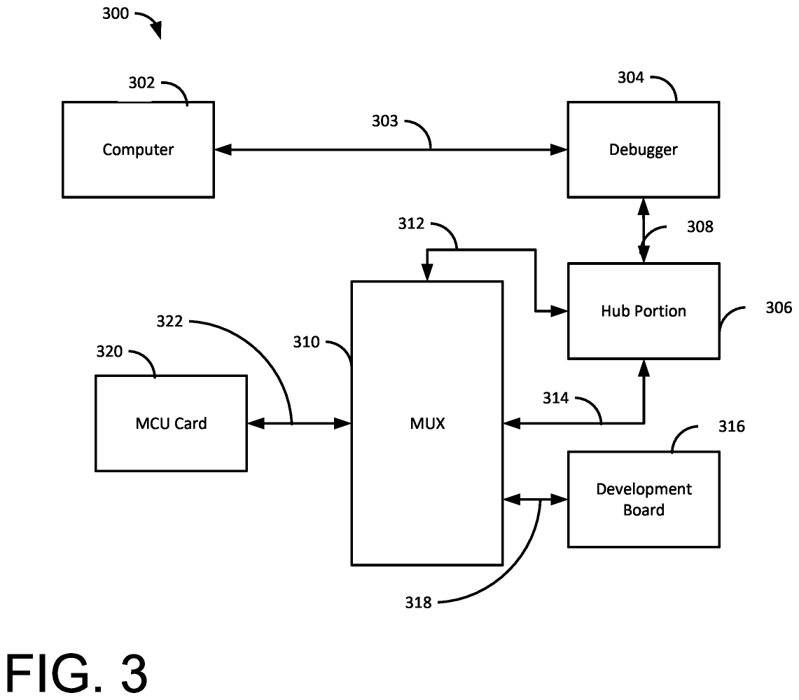

Consistent with embodiments, FIG. 3 illustrates example system 300. System 300 includes a computer portion 302 that is communicatively connected to a debugger portion 304 via a wired or wireless connection 303. The debugger portion 304 is communicatively connected to a hub portion 306 via, for example a serial protocol interface 308. The hub portion 306 is communicatively connected to a multiplexor (MUX) 310 via a channel line 312 and a channel line 314. A development board 316 is arranged to be in communicative contact with the MUX 310 via a microbus line 318. A microcontroller unit (MCU) 320 is communicatively connected to the MUX 310.

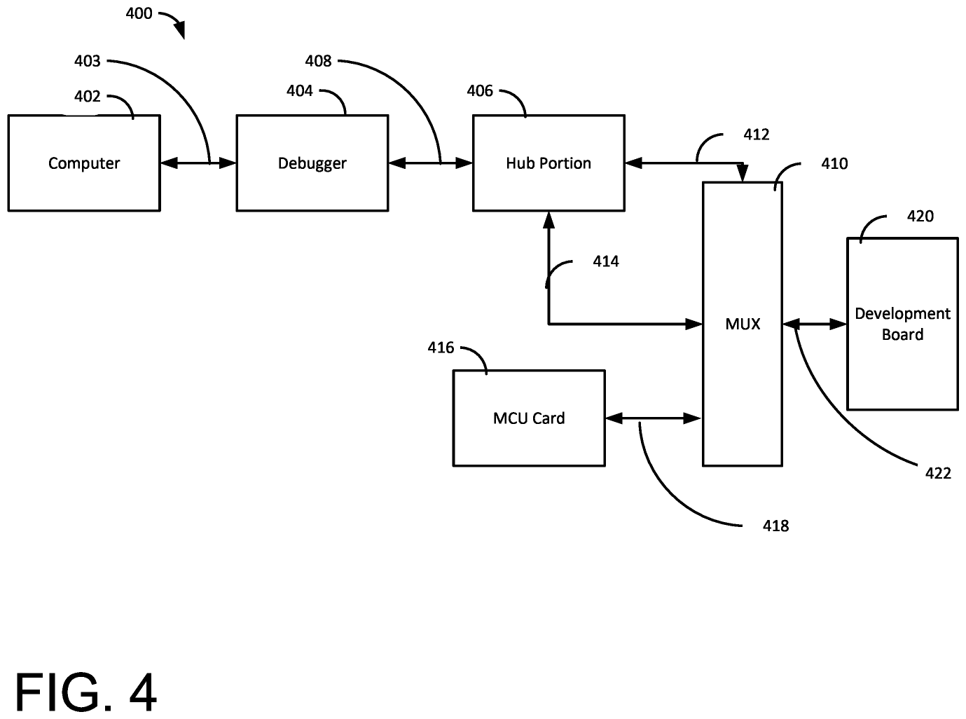

In accordance with embodiments, FIG. 4 includes example system 400. In this regard the system 400 includes a computer 402 that is communicatively connected wirelessly or by a wired connection 403 such as, for example, a serial peripheral interface to a debugger portion 404. The debugger portion 404 is communicatively connected to a hub portion 406 via, for example, a serial protocol interface 408. The hub portion 406 is communicatively connected to a multiplexor 410 via an in-channel line 412 and a line 414. The multiplexor 410 is communicatively connected to a microcontroller unit 416. The multiplexor 410 is connected to a development board 420.

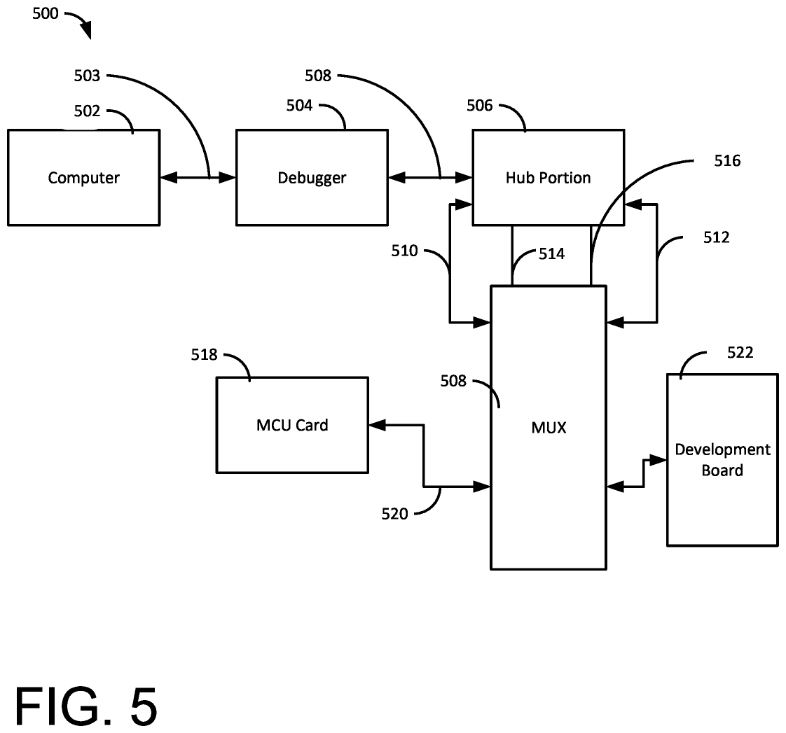

In accordance with embodiments, FIG. 5 illustrates example system 500. The system 500 is communicatively connected to a computer 502 such as, for example, a personal computer or other type of processing device such as a tablet or smart device. The computer 502 is communicatively connected to a debugger portion 504 via, for example, a wired or wireless connection 503. The debugger portion 504 is communicatively connected to a hub portion 506 via, for example a serial protocol interface. The hub portion 506 is communicatively connected to a multiplexor 508 via a channel line 510 and a microbus connection 512. An input select connection 514 and an output select connection 516 also connect the hub portion to the multiplexor 508. The multiplexor 508 is communicatively connected to a MCU card 518 via a microbus line 520. The multiplexor 508 is also communicatively connected to the development board 522 via a microbus connection 524.

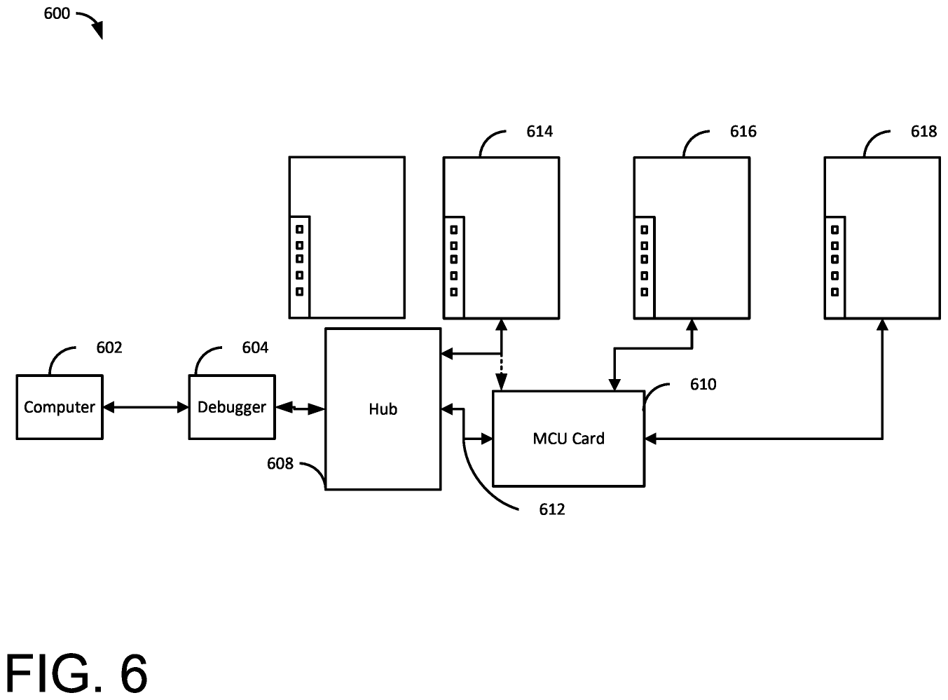

In accordance with embodiments, FIG. 6 illustrates other examples via system 600. The system 600 includes a computer 602 that is communicatively connected to a debugger 604. The debugger 604 is communicatively connected to a hub 608. The hub 608 is communicatively connected to an MCU card 610 via an asynchronous receiver transmitter (UART) connection 612. The hub and the MCU card 610 are connected to a first microbus connected to a Wi-Fi module 614. In embodiments the MCU card 610 is connected to a temperature sensing module 616 and a relay module 618 by microbuses.

The development system described above provides for a hub controlling a multiplexor that sends and receives data from a development board and a debugger. The connection of a computer or processing device with a user interface and a debugger to the hub portion provides the processing device with control data and outputs. The processing device may also receive data from the development board or an MCU card or a hardware module that is passed through the MUX to the hub portion, the debugger and computer. The development board is arranged in connection mechanically, electrically, or wirelessly with devices input and output devices such as, for example, lights, potentiometers, vibratory devices, graphical user interfaces and other input and output devices alone or in combination. These devices may be controlled by the processor device via a communicative connection that allows data to pass to and from the processor device to the development board and other devices connected to the system. The devices connected to the system may interact with each other often when a driver or other interface data is installed in the processor device. When connected the development board the attached device may send data such as drivers to the processor portion. Such features allow for a plug-and-play system where devices for testing software, hardware, or other electric circuits may connect to a system and provide the processor device with data such as, for example, drivers or other information that allows the processor device to control the system devices.

Another aspect of the disclosure is one or more computer-readable media (or computer storage apparatus) having a program, which when executed by one or more processors, such part of one or more of the systems described herein, causes the one or more processors to enable, allow or cause devices to perform any one of the methods as variously comprising any one or more of its various embodiments or sub-embodiments described above or otherwise covered by the appended claims.

In embodiments, the one or more computer-readable media are non-transitory media such as, but not limited to HDD and SSD disk drives, thumb and other flash drives, DVD's, CD's various static and dynamic storage devices and other numerous storage media.

In embodiments, the one or more computer-readable media comprise or are one or more transitory electronic signals.

The following numbered clauses set forth various embodiments of the disclosure:
1. At least one
(a) computer-implemented method,
(b) terminal, optionally by way of
(i) means for or
(ii) software module(s) for performing operation(s), or
(iii) comprising at least one processor; and at least one memory storing instruction(s) that, when executed by the at least one processor, cause the at least one processor to cause,
(c) system, optionally by way of
(i) means for, or
(ii) software module(s) for performing operation(s), or
(iii) comprising at least one processor; and at least one memory storing instructions that, when executed by the at least one processor, cause the at least one processor to cause, or
(d) transitory or non-transitory computer-readable medium (or alternately also herein throughout, computer storage apparatus) containing instructions which when executed by one or more computers each or collectively comprising one or more processors cause operation(s), according to any one of the above or below clauses, the operation(s) (or if components, the components) comprising, one or more of:
a development system comprising:
a hub portion operative to receive debugged signals and send and receive commands to a microcontroller portion;
a debugging portion communicatively connected to the hub portion;
a multiplexor communicatively connected to the hub portion; and
a development board communicatively connected to the debugger portion and the multiplexor.
2. A method, terminal, system, signal, or transitory or non-transitory computer readable medium according to any one or more of the preceding clauses further comprising a development extension board communicatively connected to the development board.
3. A method, terminal, system, signal, or transitory or non-transitory computer readable medium according to any one or more of the preceding clauses wherein the development extension board is operable to transmit an identifier of the development extension board and a manifest file, the manifest file operative to describe capabilities and connection terminals of the extension board.
4. A method, terminal, system, signal, or transitory or non-transitory computer readable medium according to any one or more of the preceding clauses, wherein the development extension board includes a file describing a feature of the development extension board.
5. A method, terminal, system, signal, or transitory or non-transitory computer readable medium according to any one or more of the preceding clauses further comprising a processor board communicatively connected to the multiplexor.
6. A method, terminal, system, signal, or transitory or non-transitory computer readable medium according to any one or more of the preceding clauses, further comprising an input and or output device communicatively connected to the development board.
7. A method, terminal, system, signal, or transitory or non-transitory computer readable medium according to any one or more of the preceding clauses further comprising a data server communicatively connected to the input device and the debugger portion.
8. A method, terminal, system, signal, or transitory or non-transitory computer readable medium according to any one or more of the preceding clauses further comprising a processing device communicatively connected to the debugger portion and a data server.
9. A method, terminal, system, signal, or transitory or non-transitory computer readable medium according to any one or more of the preceding clauses, wherein a hardware module is operable to transmit an identifier of the development extension board.
10. A method, terminal, system, signal, or transitory or non-transitory computer readable medium according to any one or more of the preceding clauses wherein a hardware module includes a file that describes a feature of the development extension board.
11. A method, terminal, system, signal, or transitory or non-transitory computer readable medium according to any one or more of the preceding clauses, wherein the multiplexor is controlled by the hub portion.
12. A method, terminal, system, signal, or transitory or non-transitory computer readable medium according to any one or more of the preceding clauses comprising:
receiving an input from a user on a processing device, the input indicating a hardware device selected by the user;
receiving an indication that a hardware device is installed in the system;
presenting a representation of the hardware device to the user on a display screen;
providing the user with a graphical representation of the system;
providing the user on the screen graphical representations of controls associated with the hardware device; and
receiving an input from a user, the input is operative to control and debug the hardware device, wherein the system is operative to emulate or change the connections of the hardware device using a hub portion of the system.
13. A method, terminal, system, signal, or transitory or non-transitory computer readable medium according to any one or more of the preceding clauses, wherein the receiving an indication that a hardware device is installed in the system includes receiving a unique identifier of the hardware device.
14. A method, terminal, system, signal, or transitory or non-transitory computer readable medium according to any one or more of the preceding clauses, wherein the receiving an indication that a hardware device is installed in the system includes receiving a manifest file describing capabilities and connections of the extension board.
15. A method, terminal, system, signal, or transitory or non-transitory computer readable medium according to any one or more of the preceding clauses, wherein after receiving an indication that a hardware device is installed in the system, the hardware device sends a manifest representing the functions of the hardware device to the processing device for display to the user.
16. A method, terminal, system, signal, or transitory or non-transitory computer readable medium according to any one or more of the preceding clauses, wherein the graphical representation of the system is on a display screen.
17. A method, terminal, system, signal, or transitory or non-transitory computer readable medium according to any one or more of the preceding clauses comprising:
receiving an input from a user on a processing device, the input indicating a hardware device selected by the user;
receiving an indication that a hardware device is installed in the system;
presenting a representation of the hardware device to the user on a display screen;
providing the user with a graphical representation of the system;
providing the user on the screen graphical representations of controls associated with the hardware device; and
receiving an input from a user, the input is operative to control and debug the hardware device, wherein the system is operative to emulate or change the connections of the hardware device using a hub portion of the system.
18. A method, terminal, system, signal, or transitory or non-transitory computer readable, wherein the receiving an indication that a hardware device is installed in the system includes receiving a unique identifier of the hardware device.
19. A method, terminal, system, signal, or transitory or non-transitory computer readable medium, wherein the receiving an indication that a hardware device is installed in the system includes receiving a file associated with a configuration of the hardware device.
20. A method, terminal, system, signal, or transitory or non-transitory computer readable medium, wherein after receiving an indication that a hardware device is installed in the system, the hardware device sends a manifest representing the functions of the hardware device to the processing device for display to the user.

What is claimed is:

1. A system for hardware and software development comprising:
a development system comprising:
a hub portion operative to receive debugged signals and send and receive commands to a microcontroller portion;
a debugging portion communicatively connected to the hub portion;
a multiplexor communicatively connected to the hub portion; and
a development board communicatively connected to the debugging portion and the multiplexor.

2. The system of claim 1, further comprising a development extension board communicatively connected to the development board.

3. The system of claim 2, wherein the development extension board is operable to transmit an identifier of the development extension board and a manifest file, the manifest file operative to describe capabilities and connection terminals of the development extension board.

4. The system of claim 2, wherein the development extension board includes a file describing a feature of the development extension board.

5. The system of claim 1, further comprising a processor board communicatively connected to the multiplexor.

6. The system of claim 1, further comprising an input output device communicatively connected to the development board.

7. The system of claim 6 further comprising a data server communicatively connected to the input output device and the debugging portion.

8. The system of claim 1, further comprising a processing device communicatively connected to the debugging portion and a data server.

9. The system of claim 4, wherein a hardware module is operable to transmit an identifier of the development extension board and a manifest file, the manifest file operative to describe functions and connection terminals of the hardware module.

10. The system of claim 2, wherein a hardware module includes a file that describes a feature of the hardware module.

11. The system of claim 1, wherein the multiplexor is controlled by the hub portion.

12. A method for operating a system, the method comprising:
receiving an input from a user on a processing device, the input indicating a hardware device selected by the user;
receiving an indication that a hardware device is installed in the system;
presenting a representation of the hardware device to the user on a display screen;
providing the user with a graphical representation of the system;
providing the user in the graphical representations of controls associated with the hardware device; and
receiving an input from a user, the input is operative to control and debug the hardware device, wherein the system is operative to emulate or change connections of the hardware device using a hub portion of the system.

13. The method of claim 12, wherein the receiving an indication that a hardware device is installed in the system includes receiving a unique identifier of the hardware device.

14. The method of claim 12, wherein the receiving an indication that a hardware device is installed in the system includes receiving a manifest file describing capabilities and connections of a hardware device.

15. The method of claim 12, wherein after receiving an indication that a hardware device is installed in the system, the hardware device sends a manifest representing a function of the hardware device to the processing device for display to the user.

16. The method of claim 12, wherein the graphical representation of the system is on a display screen.

17. A method, terminal, system, signal, or transitory or non-transitory computer readable medium comprising:
receiving an input from a user on a processing device, the input indicating a hardware device selected by the user;
receiving an indication that a hardware device is installed in the system;
presenting a representation of the hardware device to the user on a display screen;
providing the user with a graphical representation of the system;
providing the user on a screen, graphical representations of controls associated with the hardware device; and
receiving an input from a user, the input is operative to control and debug the hardware device, wherein the system is operative to emulate or change connections of the hardware device using a hub portion of the system.

18. The method, terminal, system, signal, or transitory or non-transitory computer readable medium according to claim 17, wherein the receiving an indication that a hardware device is installed in the system includes receiving a unique identifier of the hardware device.

19. The method, terminal, system, signal, or transitory or non-transitory computer readable medium according to claim 17, wherein the receiving an indication that a hardware device is installed in the system includes receiving a file associated with a configuration of the hardware device.

20. The method, terminal, system, signal, or transitory or non-transitory computer readable medium according to claim 17, wherein after receiving an indication that a hardware device is installed in the system, the hardware device sends a manifest representing functions of the hardware device to a processing device for display to the user.
